(19) United States
(12) Patent Application Publication
(10) Pub. No.: US 2005/0141562 A1
(43) Pub. Date: Jun. 30, 2005

(54) Method for reducing radio interference in a frequency-hopping radio network

(75) Inventors: Hongyuan Chen, Tokyo (JP); Leping Huang, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/749,202

(22) Filed: Dec. 30, 2003

(51) Int. Cl. H04J 1/00

(52) U.S. Cl. 370/480; 370/343

(57) ABSTRACT

A method for reducing interference between a first frequency-hopping radio communications network and a second frequency-hopping radio communications network, comprising: predicting a possible collision between a transmission at a first frequency in the first frequency-hopping radio communication network and a transmission at the first frequency in the second frequency-hopping radio communication network; and controlling transmission in one of the first frequency-hopping radio communications network and the second frequency-hopping radio communications network to avoid the collision. Also described is a method for controlling the operation of a Master transceiver of a first frequency-hopping radio communications network, comprising: determining the duration for which transmissions at a single frequency can occur in the first frequency-hopping network without a potential collision with transmissions at that frequency in neighboring frequency-hopping networks; and controlling multi-slot communication in the first frequency-hopping radio communications network in dependence upon the determination.

### TECHNICAL FIELD

Some embodiments of the invention relate to a method for reducing interference in a frequency-hopping radio network. Other embodiments of the invention relate to a method for controlling a Master of a frequency-hopping radio network, to reduce radio interference.

### BACKGROUND OF THE INVENTION

Bluetooth (trademark) is a low power radio frequency (LPRF) packet communications technology. Bluetooth enabled devices can create ad-hoc wireless networks (piconets) via short-range radio frequency hopping spread spectrum (FHSS) communication links in the 2.4 GHz frequency spectrum. These links may be of the order of 10 m.

A piconet is controlled by a Master and can contain up to seven Slaves. The piconet has a star-topology with the Master as the central node and the Slaves as dependent nodes. The timing of the piconet is controlled by the Master and the Slaves synchronize their Bluetooth clocks to the Bluetooth clock of the Master.

All communications within the piconet include the Master. A Slave cannot communicate directly with another Slave in the piconet, but instead communicates with the Master which then communicates with the other Slave.

The communications within the piconet are time divided into slots of 625 microsecond duration. Communications from the Master may only commence in even numbered time slots and communications from the Slaves may only commence in odd numbered time slots.

The frequency at which a communication is made is dependent upon the time slot at which it begins. The Master defines a frequency hopping sequence (FHS) that all the devices in a piconet share. The sequence is derived from the Bluetooth address of the Master. The frequency used in the piconet hops every 2 slots (1250 microseconds) in phase with the Master Bluetooth clock sequentially along the FHS.

The Master creates a piconet by paging its slaves one by one. All Bluetooth devices that receive the paging, by page-scan, synchronize their Bluetooth clocks to that of the Master and communicate with the Master using the Master's Bluetooth Device address as the packet Access Code.

Piconets may overlap, so a Slave in one piconet can be a Master or Slave in an adjacent piconet. A collection of interconnected piconets is called a scafternet. The Bluetooth device that is common to two piconets, the interconnecting node, is able to route packets from one piconet to the connected piconet.

A scafternet may be desirable if there are more that eight devices which need to be interconnected or where the physical spread of devices is greater than the radio communication range of a single device.

As Bluetooth devices become more common, it becomes more likely that a transmitting device will be within communication range of another device that is simultaneously transmitting at the same frequency. In this situation the transmissions ‘collide’ and interfere with each other. This is disadvantageous as it requires retransmissions by both devices, which consumes more power and bandwidth.

### BRIEF SUMMARY OF THE INVENTION

According to one embodiment of the invention there is provided a method for reducing interference between a first frequency-hopping radio communications network and a second frequency-hopping radio communications network, comprising: predicting a possible collision between a transmission at a first frequency in the first frequency-hopping radio communication network and a transmission at the first frequency in the second frequency-hopping radio communication network; and controlling transmission in one of the first frequency-hopping radio communications network and the second frequency-hopping radio communications network to avoid the collision.

According to another embodiment of the invention there is provided a method for reducing interference between a first frequency-hopping radio communications network and a second frequency-hopping radio communications network, comprising at a Master of the first frequency-hopping radio communications network: predicting a possible collision between a packet to be transmitted at a first time at a first frequency in the first frequency-hopping radio communication network and a transmission at the first frequency in the second frequency-hopping radio communication network; and controlling transmission in the first frequency-hopping radio communications network to avoid the collision.

According to another embodiment of the invention there is provided a method for reducing interference in a first piconet, comprising: calculating whether one or more of the future transmissions within the first piconet can collide with transmissions within piconets neighboring the first piconet; and determining whether to modify a future transmission within the first piconet.

According to another embodiment of the invention there is provided a method for controlling the operation of a Master transceiver of a first frequency-hopping radio communications network, comprising: determining the duration for which transmissions at a single frequency can occur in the first frequency-hopping network without a potential collision with transmissions at that frequency in neighboring frequency-hopping networks; and controlling multi-slot communication in the first frequency-hopping radio communications network in dependence upon the determination.

According to another embodiment of the invention there is provided a method for controlling the operation of a Master transceiver of a first frequency-hopping radio communications network, comprising: determining when a future modification to a transmission from the Master transceiver is required; and controlling multi-slot communication in the first frequency-hopping radio communications network in dependence upon the determination.

Embodiments of the invention provide for less interference, lower power consumption and improved data throughput.

### BRIEF DESCRIPTION OF DRAWINGS

For a better understanding of the present invention reference will now be made by way of example only to the accompanying drawings in which:

FIG. 1 illustrates an example of a Bluetooth (trademark) scafternet;

FIG. 2 illustrates a process that occurs at Master Mo for controlling single-slot radio access;

FIG. 3 illustrates a process that occurs at Master Mo for controlling multiple-slot radio access; and

FIG. 4 illustrates the transmission in three piconets, each of which use the access procedure illustrated in FIG. 3.

### DETAILED DESCRIPTION OF EMBODIMENT(S) OF THE INVENTION

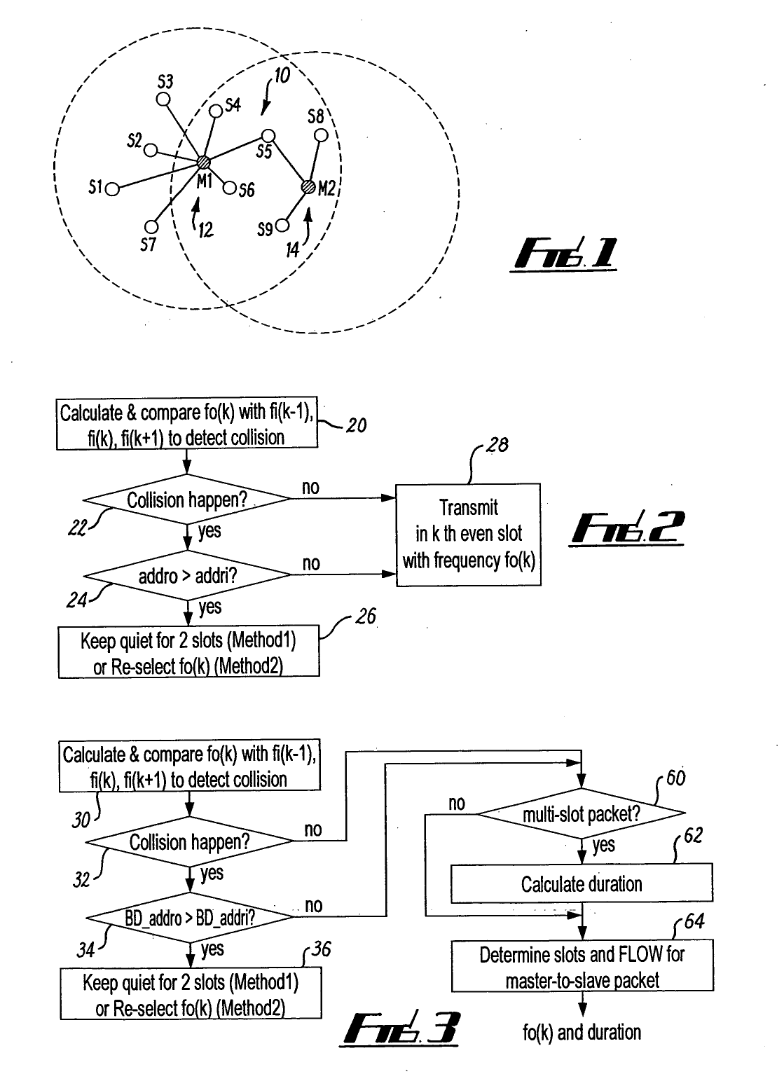

FIG. 1 illustrates an example of a Bluetooth (trademark) scatternet 10. The scafternet is a distributed LPRF network that, in this example, comprises two separate piconets that are interconnected by a common node. Each piconet has a star-topology comprising a central Master node and a plurality of dependent Slave nodes and forms a sub-network of the scatternet 10.

A first piconet 12 is controlled by the Master M1 and includes seven Slaves S1, S2, S3, S4, S5, S6 and S7. A second piconet 14 is controlled by the Master M2 and includes three Slaves S5, S8 and S9. The Slave S5 is a common node interconnecting the first piconet 12 with the second piconet 14.

Each of the Masters and Slaves is a Bluetooth-enabled device. Such a device may operate as a Master or a Slave depending upon circumstances. The Bluetooth devices may be mobile.

Each of the Masters M1 and M2 collect frequency-hopping information about their neighboring piconets. This frequency hopping information includes the Bluetooth addresses of the Masters of the neighboring piconets and the clock offsets of the Masters of the neighboring piconets.

In this example, the first piconet 12 controlled by Master M1 has a single neighboring piconet, the second piconet 14 controlled by Master M2. The Master M1 uses the Bluetooth address of the Master M2 to emulate the frequency hopping sequence (FHS) of the second piconet 14 and uses the clock offset of the Master M2 to determine the Bluetooth clock value of the second piconet 14. This clock value determines the phase of the FHS in the second piconet 14, thus allowing the Master M1 to determine when the Master M2 can transmit and with what frequency.

Likewise, the second piconet 14 controlled by Master M2 has a single neighboring piconet, the first piconet 12 controlled by Master M1. The Master M2 uses the Bluetooth address of the Master M1 to emulate the frequency hopping sequence (FHS) of the first piconet 12 and uses the clock offset of the Master M1 to determine the Bluetooth clock value of the first piconet 12. This clock value determines the phase of the FHS in the first piconet 12, thus allowing the Master M1 to determine when the Master M2 can transmit and with what frequency.

The Bluetooth addresses and clock offsets of neighboring Masters can be obtained in a variety of different ways.

According to one embodiment, neighboring Masters are Masters that control directly interconnected piconets in the same scatternet. In this scenario, the Masters will either be directly connected or indirectly connected via a single interconnecting Slave. A Master broadcasts a request to each of the Slaves in the piconet it controls. If a Slave that receives the request is connected to another Master, it replies with the Bluetooth address of that Master and the clock value or offset for that Master. If a Slave that receives the request also operates as a Master in a different piconet, it replies either with an indication of this or with its Bluetooth address and clock value or offset. An indication is possible as a reply, as the requesting Master should already store the Bluetooth address and the clock value or offset for its Slaves.

According to another embodiment, neighboring Masters are Masters that control indirectly interconnected piconets in the same scatternet. In this scenario, the piconets do not have a common interconnecting node. A Master may obtain the Bluetooth addresses and the clock values or offsets of all active Bluetooth devices within radio communication range of itself by performing an Inquiry. A Master may obtain the Bluetooth addresses and the clock values or offsets of all active Bluetooth devices within radio communication range of its Slaves by instructing each of them to perform separately an Inquiry and return the results to the Master. The Master may in this way identify all the neighboring Bluetooth devices that may interfere with it and with its Slaves. The Master then determines which of these neighboring Bluetooth devices are operating as Masters in the scatternet. This may be achieved by sending a request message into the scatternet. Each node the request message passes through adds its address to a history contained in the message and forwards it on to the next node. A node, if it is operating as a Master, additionally sends a reply message back to the Master. The history is used to route the reply message back. The reply message includes the Bluetooth address of the Master. Thus neighboring Masters can be identified within the neighboring devices and their Bluetooth addresses and clock values used.

According to another embodiment, neighboring Masters are Masters that control piconets that are within radio communication range whether or not they are in the same scatternet. A Master may identify all the neighboring Bluetooth devices that may interfere with it and with its Slaves by using an adapted Inquiry procedure. In the normal Inquiry procedure, devices that are within range respond with their Bluetooth address and Bluetooth clock value. In the adapted Inquiry procedure, the devices that are currently operating as Masters additionally indicate this in their response. A Master may obtain the Bluetooth addresses and the clock values or offsets of all active Bluetooth Masters with radio communication range of itself by performing an adapted Inquiry. The Master may obtain the Bluetooth addresses and the clock values or offsets of all active Bluetooth Masters with radio communication range of its Slaves by instructing each of them to perform separately an adapted Inquiry and return the results to the Master.

The Bluetooth addresses and Bluetooth clock offsets of neighboring Masters are used to modify the Master access procedure and thus avoid transmissions in neighboring piconets colliding.

One Slot Transmission

For ease of explanation, the inventive process will be described for a specific scenario in which transmissions may only be of one slot duration. The process for the general scenario of longer multi-slot transmissions will be described later.

As a transmission may only be of one slot duration and since a Slave uses the same frequency for transmission in the odd slot following the even slot in which the Master addressed the Slave, the minimum duration that a frequency is used for is two slots (1250 microseconds). Thus the frequency hops at every even time-slot if only one-slot transmission is used.

Let us consider the Master Mo, which controls the piconet Po. Let there be N neighboring piconets Pi ( where i=1, 2 . . . N.). Each piconet Pi is controlled by a Master Mi. The Master Mo has, for each Master Mi, that Master's Bluetooth address BD_ADDR(i) and Bluetooth Clock value CLK(i).

The process that occurs at Master Mo for controlling radio access by Mo is illustrated in FIG. 2.

At step 20 the Master Mo calculates fo(k), which is the frequency used in Po for the k th even time slot. This frequency would in the absence of the invention be used for transmission in Po at the time slots 2k and 2k+1.

Master Mo additionally calculates the frequencies that could be used simultaneously with the time slots 2k and 2k+1 of Po in all neighboring piconets. To do this, the Master Mo uses each BD_ADDR(i) to calculate the FHS for each piconet Pi and uses CLK(i) to determine the phase within the sequence for each piconet Pi.

The Master Mo is therefore able to calculate fi(k),fi(k−1), and fi(k+1) for i=1, 2 . . . N. fi(k) is the frequency used in Pi for the k th even time slot, i.e. for time slots 2k and 2k+1. fi(k−1) is the frequency used in Pi for the k−1 th even time slot i.e. for time slots 2k−2 and 2k−1. fi(k+1) is the frequency used in Pi for the k+1 th even time slot i.e. for time slots 2k+1, 2k+2.

The Master then compares fo(k) with fi(k−1), fi(k), fi(k+1), for i=1, 2 . . . N. It is necessary to make a comparison with fi(k−1) and fi(k+1) because piconets are not synchronized to each other and slots in different piconets may partially overlap.

At step 22, if fo(k)=fi(k−1), or if fo(k)=fi(k) or if fo(k)=fi(k+1), then a collision can occur.

If a collision can occur between the piconet Po and, say the piconet Pm then one of the piconets transmits as normal where the collision may occur and transmissions in the other piconet are modified where the collision may occur. The process moves to step 24.

If a collision cannot occur the process moves to step 28.

At step 24, a decision must be made as to whether the piconet Po should transmit as normal or should have its transmissions modified. The decision process occurs without communication between the Master Mo and the Master Mm. One way of making the decision is on the basis of the BD_ADDR(i) and BD_ADDR(m). If the BD_ADDR of the local device, i.e. BD_ADDR(o), is greater than the BD_ADDR of the remote device, i.e. BD_ADDR(m), then the transmissions in the piconet Po are modified and the transmission in the piconet Pm are unmodified. If BD_ADDRo is less than BD_ADDR(m), then the transmissions in the piconet Po for slots are unmodified, and transmissions in the piconet Pm are modified. Thus if BD_ADDR(o)>BD_ADDR(m) then the process moves to step 26, otherwise it moves to step 28.

At step 28, the Master Mo transmits as normal, that is with a frequency fo(k) at the slot 2k.

At step 26, the transmissions in the piconet Po are modified. The modification may prevent the Master Mo transmitting in the slot 2k, which prevents the Slaves transmitting in the next slot 2k+1. This creates a quiet period of two slots in the piconet Po.

Alternatively, the transmissions in the piconet Po may be modified by adapting the frequency at which the Master Mo transmits and therefore also the frequency at which the Slave transmits in reply. For this embodiment, the Master Mo must send the Bluetooth addresses and clock offsets of the Masters that neighbor Mo to the Slaves of Po which also calculate when the transmissions in the piconet Po can collide with transmissions of a neighboring piconet. There must also be a common algorithm that is used to select the modified frequency f′ in the Master Mo and in the Slaves of the piconet Po. The modified frequency will be such that fo′(k) is not equal to fi(k−1), fi(k) or fi(k+1), for i=1,2 . . . N.

It should be appreciated that step 24 may precede step 20 and step 22 may directly precede step 26. In this case, steps 20 and 22 are performed only for the sub-set of piconets Pi, for which BD_ADDR(i)<BD_ADDR(o).

Multi-Slot Transmission

Let us now consider the access procedure when multi-slot transmissions are possible. The Master Mo controls the piconet Po, which has N neighboring piconets Pi, where i=1, 2 . . . N. Each piconet Pi is controlled by a Master Mi. The Master Mo has, for each Master Mi, that Master's Bluetooth address BD_ADDR(i) and Bluetooth Clock value CLK(i).

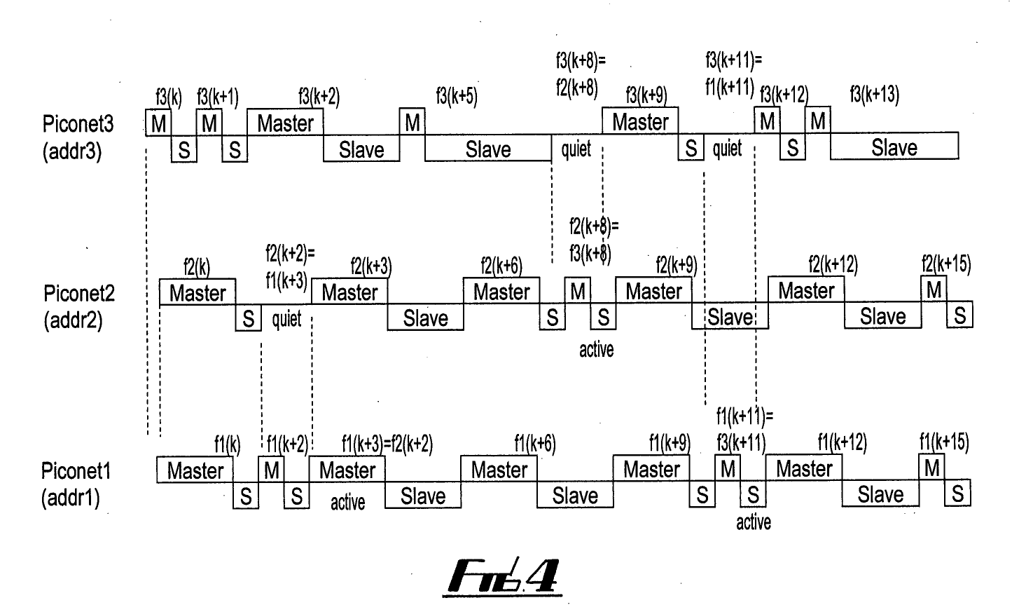

The process that occurs at Master Mo for controlling radio access by Mo is illustrated in FIG. 3.

At step 30 the Master Mo calculates fo(k) the frequency used in Po for the kth even time slot. This frequency would in the absence of the invention be used for transmission in Po at least the time slots 2k and 2k+1.

Master Mo additionally calculates the frequencies that could be used simultaneously with the time slots 2k and 2k+1 of Po in all neighboring piconets. To do this, the Master Mo uses each BD_ADDR(i) to calculate the FHS for each piconet Pi and uses CLK(i) to determine the phase within the sequence for each piconet Pi.

The Master Mo is therefore able to calculate fi(k),fi(k−1), fi(k+1) for each piconet Pi. fi(k) is the frequency used in Pi for the k th even time slot, i.e. for at least the time slots 2k and 2k+1. fi(k−1) is the frequency used in Pi for the k−1 th even time slot i.e. for at least the time slots 2k−2 and 2k−1. fi(k+1) is the frequency used in Pi for the k+1 th even time slot i.e. for at least the time slots 2k+1, 2k+2.

The Master then compares fo(k) with fi(k−1), fi(k), fi(k+1), for i=1, 2 . . . N. It is necessary to make a comparison with fi(k−1) and fi(k+1) because piconets are not synchronized and slots in different piconets may partially overlap.

At step 32, if fo(k)=fi(k−1), or if fo(k)=fi(k) or if fo(k)=fi(k+1), for any one of i=1,2 . . . N, then a collision can occur and the process moves to step 34. If a collision cannot occur then the process moves to step 60.

If a collision can occur between the piconet Po and, say the piconet Pm then one of the piconets transmits as normal where the collision may occur whereas transmissions in the other piconet are modified where the collision may occur.

At step 34, a decision must be made as to whether the piconet Po should transmit as normal or should have its transmissions modified. The decision process occurs without communication between the Master Mo and the Master Mm. One way of making the decision is on the basis of the BD_ADDR(o) and BD_ADDR(m). If BD_ADDR(o) is greater than BD_ADDR(m), then the process moves to step 36. If BD_ADDRo is less than BD_ADDR(m), then the process moves to step 60.

At step 36, transmissions in the piconet Po are modified for slots 2k and 2k+1 and the transmission in the piconet Pm are unmodified. The transmissions in the piconet Po may be modified by preventing the Master Mo transmitting in the slot 2k, which prevents the Slaves transmitting in the next slot 2k+1.

Alternatively, the transmissions in the piconet Po, may be modified by modifying the frequency at which the Master Mo transmits and the Slave transmits in reply. For this embodiment, the Master Mo must send the Bluetooth addresses and clock offsets of the Masters that are neighbors of the Master Mo to the Slaves of Po. The Slaves of Po also calculate when the transmissions in the piconet Po can collide with transmissions of a neighboring piconet. There must also be a common algorithm that is used to select the modified frequency f′ in the Master Mo and in the Slaves of the piconet Po. The modified frequency will be such that fo′(k) is not equal to fi(k−1), fi(k) or fi(k+1), for i=1,2 . . . N.

At step 60, it is determined whether multi-slot packets are supported in the piconet Po. If multi-slot packets are supported the process moves to step 62. If multi-slot packets are not supported the process moves to step 64.

At step 62, the Master Mo calculates a maximum duration for collision free transmissions at frequency fo in piconet Po starting with the slot 2k. The following algorithm may be used to calculate the duration.
If fo(k)=fi(k+2) for i=1, 2 , , , or N, then the duration=2 slots else
If fo(k)=fi(k+3) for i=1, 2 , , , or N, then the duration=4 slots else
If fo(k)=fi(k+4), for i=1, 2 , , , or N, then the duration=6 slots else
If fo(k)=fi(k+5), for i=1, 2 , , , or N, then the duration=8 slots else
   duration is unconstrained

If a collision can occur between a multi-slot transmission in the piconet Po and, say the piconet Pm then one of the piconets transmits as normal where the collision may occur whereas transmissions in the other piconet are modified where the collision may occur.

A decision must be made as to whether the piconet Po should transmit as normal or should have its transmissions modified. The decision process occurs without communication between the Master Mo and the Master Mm. One way of making the decision is on the basis of the BD_ADDR(o) and BD_ADDR(m). If BD_ADDR(o) is greater than BD_ADDR(m), then the piconet Po can transmit at frequency fo(k) for a maximum of duration slots. If BD_ADDR(o) is less than BD_ADDR(m), then the Master Mo can transmit at frequency fo(k) for any duration. The process then moves to step 64.

At step 64, the Master Mo sends an indication to the Slave, in slot 2k, that informs it whether it should restrict to a single, three-slot or five-slot packet in the following slave to master transmission.

A slave that receives a packet with FLOW=0 will not send a data packet to the Master Mo, otherwise it can send any type of packets agreed with Master Mo.

If a 1-slot only packet between Master and Slave is supported, then the packet transmitted by the Master has a size and FLOW value according to the following table:

| | Packets that can be | FLOW value in |
|---|---|---|
| Duration | transmitted by Master | transmitted packet |
| 2 | 1-slot | 1 |
| 4 | 1-slot | 1 |
| 6 | 1-slot | 1 |
| 8 | 1-slot | 1 |
| 10+ | 1-slot | 1 |

If 1-slot and 3-slot packets between Master and Slave are supported, then the packet transmitted by the Master has a size and FLOW value according to the following table:

| | Packets that can be | FLOW value in |
|---|---|---|
| Duration | transmitted by Master | transmitted packet |
| 2 | 1-slot | 0 |
| 4 | 1-slot | 1 |
| | 3-slot | 0 |
| 6 | 1-slot | 1 |
| | 3-slot | 1 |
| 8 | 1-slot | 1 |
| | 3-slot | 1 |
| 10+ | 1-slot | 1 |
| | 3-slot | 1 |

If 1-slot, 3-slot and 5-slot packets between Master and Slave are supported, then the packet transmitted by the Master has a size and FLOW value according to the following table:

| | Packets that can be | FLOW value in |
|---|---|---|
| Duration | transmitted by Master | transmitted packet |
| 2 | 1-slot | 0 |
| 4 | 1-slot | 0 |
| | 3-slot | 0 |
| 6 | 1-slot | 1 |
| | 3-slot | 0 |
| | 5-slot | 0 |
| 8 | 1-slot | 1 |
| | 3-slot | 1 |
| | 5-slot | 0 |
| 10+ | 1-slot | 1 |
| | 3-slot | 1 |
| | 5-slot | 1 |

FIG. 4 illustrates the results of the above described access procedure for three neighboring piconets. In this access procedure if there is a potential collision, the Master with greater BD_ADDR does not transmit. This has the advantage that no modification is required to the Slaves for the new access procedure to work.

The Figure identifies the transmissions that occur within each of three neighboring piconets with the passage of time. It should be noted that the timing of the different piconets are not synchronized, that is, there is not inter-piconet synchronization. Master transmissions within a piconet are identified by ‘M’ if the transmission is for a single slot and by ‘Master’ if the transmission is for a consecutive series of slots at a single frequency. Slave transmissions within a piconet are identified by ‘S’ if the transmission is for a single slot and by ‘Slave’ if the transmission is for a consecutive series of slots at a single frequency.

The frequency of the Master transmissions are annotated on the Figure. The Slave transmission in the piconet will immediately follow a Master transmission in that piconet and will be at the same frequency as that Master transmission.

In the Figure, the BD_ADDR of piconet 3, is greater than the BD_ADDR of piconet 2, which is greater than the BD_ADDR of piconet 1. When there is a collision between two piconets, the piconet that has the Master with the greater BD_ADDR is quiet and does not transmit for two slots starting from the n th even slot at which the collision would happen.

Piconet 1 is never quiet as it has the Master with the lowest BD_ADDR.

Piconet 2 is quiet for the pair of slots starting with the k+2 th even slot, that is slots 2k+4 and 2k+5. This is because there would be a (part) collision between f2(k+2) and f1(k+3) as a result of lack of synchronization between the Piconet 1 and the Piconet 2. This quietness is achieved by preventing the Master of Piconet 2 transmitting in slot 2k+4.

Although f1(k+3) would collide with f2(k+2), the Master in Piconet 1 starts a transmission at k+3 that lasts for six slots, because collision is avoided between f1(k+3) and f2(k+2) by the quietness of the Piconet 2.

Piconet 3 is quiet for the pair of slots starting with the k+8 th even slot, that is slots 2k+18 and 2k+19. This is because there is a collision between f3(k+8) and f2(k+8). This quietness is achieved by preventing the Master of Piconet 3 transmitting in slot 2k+18.

Piconet 3 is quiet for the pair of slots starting with the k+11 th even slot, that is slots 2k+22 and 2k+23. This is because there is a collision between f3(k+11) and f1(k+11). This quietness is achieved by preventing the Master of Piconet 3 transmitting in slot 2k+22.

The avoidance of collisions by making one of the potentially colliding piconets quiet has the advantage that it does not require the Slaves to operate in a new way, only the Masters must operate in a new way. However, potential bandwidth is lost because of the unused slots during the quietness.

The avoidance of collisions by making one of the potentially colliding piconets adapt its frequency has the advantage that optimal bandwidth is maintained as quiet periods are avoided. However, it requires that the Slaves are capable of predicting collisions between piconets and the communication of information from the Master to the Slaves to allow them to do this.

Although embodiments of the present invention have been described in the preceding paragraphs with reference to various examples, it should be appreciated that modifications to the examples given can be made without departing from the scope of the invention as claimed.

1. A method for reducing interference between a first frequency-hopping radio communications network and a second frequency-hopping radio communications network, comprising:
predicting a possible collision between a transmission at a first frequency in the first frequency-hopping radio communication network and a transmission at the first frequency in the second frequency-hopping radio communication network; and
controlling transmission in one of the first frequency-hopping radio communications network and the second frequency-hopping radio communications network to avoid the collision.

2. A method as claimed in claim 1, wherein the step of predicting occurs at a Master of the first frequency-hopping radio communications network and comprises:
comparing the first frequency with calculated frequencies that are expected to be used for transmission in the second frequency-hopping radio communication network at the same time as the transmission at the first frequency in the first frequency-hopping radio communication network.

3. A method as claimed in claim 2, wherein the calculated frequencies are calculated at the Master of the first frequency-hopping radio communications network by using the address of the Master of the second frequency-hopping radio communication network and a knowledge of the timing of the second frequency-hopping radio communication network.

4. A method as claimed in claim 3, wherein the Master of the first frequency-hopping radio communications network emulates the clock of the Master device of the second frequency-hopping radio communication network.

5. A method as claimed in claim 1, wherein the step of predicting occurs at a Master of the first frequency-hopping radio communications network and comprises:
calculating a frequency hopping schedule for the second frequency-hopping radio communication network;
determining from the calculated frequency hopping schedule three consecutive frequencies at least one of which will be used for transmission in the second frequency-hopping radio communication network at the same time as the transmission at the first frequency in the first frequency-hopping radio communication network; and
comparing the first frequency with the determined frequencies.

6. A method as claimed in claim 5, wherein the frequency hopping schedule is calculated using an address of a Master device of the second frequency-hopping radio communication network.

7. A method as claimed in claim 1, wherein the step of controlling transmission in one of the first frequency-hopping radio communications network and the second frequency-hopping radio communications network comprises temporarily silencing one or other of the first and second frequency-hopping radio networks.

8. A method as claimed in claim 1, wherein the step of controlling transmission in one of the first frequency-hopping radio communications network and the second frequency-hopping radio communications network comprises adapting the frequency of transmission of one or other of the first and second frequency-hopping radio networks.

9. A method as claimed in claim 1, further comprising selecting which of the first and second frequency-hopping networks is to have its transmission controlled using a predetermined criterion shared between the first and second frequency-hopping networks.

10. A method as claimed in claim 9, wherein the predetermined criterion involves an address of a Master of the first network and an address of a Master of the second network.

11. A method as claimed in claim 1, wherein the first frequency-hopping radio communication network is a Bluetooth piconet and the second frequency-hopping radio communication network is a Bluetooth piconet.

12. A method as claimed in claim 11, wherein the first frequency-hopping radio communication network and the second frequency-hopping radio communication network are part of a Bluetooth scatternet,

13. A method as claimed in claim 12, wherein the first frequency-hopping radio communication network and the second frequency-hopping radio communication network are part of a Bluetooth scatternet and share a common interconnecting node.

14. A method as claimed in claim 1 wherein the first frequency-hopping radio communication network and the second frequency-hopping radio communication network are ad-hoc networks that include mobile nodes.

15. A method as claimed in claim 1 wherein the first frequency-hopping radio communication network and the second frequency-hopping radio communication network are not bit synchronized.

16. A method for reducing interference between a first frequency-hopping radio communications network and a second frequency-hopping radio communications network, comprising at a Master of the first frequency-hopping radio communications network:
predicting a possible collision between a packet to be transmitted at a first time at a first frequency in the first frequency-hopping radio communication network and a transmission at the first frequency in the second frequency-hopping radio communication network; and
controlling transmission in the first frequency-hopping radio communications network to avoid the collision.

17. A method as claimed in claim 16, wherein before the step of controlling transmission, the Master determines whether or not to control transmission using a predetermined criterion shared between the first and second frequency-hopping networks.

18. A method as claimed in claim 16, wherein controlling transmission in the first frequency-hopping radio communications network involves delaying the transmission of the first packet

19. A method as claimed in claim 16, wherein controlling transmission in the first frequency-hopping radio communications network involves preventing transmission at the first time by the Master of the first frequency-hopping radio communications network.

20. A method as claimed in claim 16, wherein controlling transmission in the first frequency-hopping radio communications network involves adapting the frequency of transmission of the first packet at the first time.

21. A method for reducing interference in a first piconet, comprising:
calculating whether one or more of the future transmissions within the first piconet can collide with transmissions within piconets neighboring the first piconet; and
determining whether to modify a future transmission within the first piconet.

22. A method as claimed in claim 21, wherein the step of calculating involves comparing the frequency of the a future transmission within the first piconet with the frequencies of a series of potentially overlapping transmissions from each neighboring piconet.

23. A method for controlling the operation of a Master transceiver of a first frequency-hopping radio communications network, comprising:
determining the duration for which transmissions at a single frequency can occur in the first frequency-hopping network without a potential collision with transmissions at that frequency in neighboring frequency-hopping networks; and
controlling multi-slot communication in the first frequency-hopping radio communications network in dependence upon the determination.

24. A method as claimed in claim 23, wherein the sum of the duration of a transmission at the single frequency by the Master and the duration of a transmission at the single frequency by the Slave in response, do not exceed the determined duration.

25. A method as claimed in claim 23, wherein the Master indicates to the Slave in a transmission at the single frequency the maximum duration of a reply by the Slave.

26. A method as claimed in claim 23, wherein controlling multi-slot communication in the first frequency-hopping radio communications network comprises allocating at least one multi-slot communication for use in the duration for which transmissions at a single frequency can occur without a potential collision.

27. A method as claimed in claim 23, wherein the step of determining comprises identifying at least one possible future collision and deciding whether the Master modifies its transmission to avoid that collision.

28. A method as claimed in claim 23, wherein the step of determining comprises identifying the type of collisions for which the Master modifies its transmission and identifying a potential future collision of that type.

29. A method for controlling the operation of a Master transceiver of a first frequency-hopping radio communications network, comprising:
determining when a future modification to a transmission from the Master transceiver is required; and
controlling multi-slot communication in the first frequency-hopping radio communications network in dependence upon the determination

30. A method as claimed in claim 29, wherein the future modification is a modification to a frequency-hopping schedule that predetermines a frequency of a transmission according to the time at which the transmission starts.

31. A method as claimed in claim 29, wherein the future modification avoids a collision between a transmission in a first frequency-hopping radio communications network and a transmission within a second frequency-hopping radio communications network.
